(19) United States
(12) Patent Application Publication
(10) Pub. No.: US 2023/0140201 A1
(43) Pub. Date: May 4, 2023

(54) BRAKE PISTON AND BRAKE CALIPER

(71) Applicant: ZF Active Safety GmbH, Koblenz (DE)

(72) Inventors: Guido Zenzen, Macken (DE); Marco Becker, Oberduerenbach (DE); Peter Maeurer, Koblenz (DE); Paul Wecker, Limburg (DE); Michael Schog, Mertloch (DE)

(21) Appl. No.: 17/974,268

(22) Filed: Oct. 26, 2022

(30) Foreign Application Priority Data
Oct. 29, 2021 (DE) 102021128309.4

(51) Int. Cl. F16D 65/18; B60T 13/58

(52) U.S. Cl. CPC F16D 65/18; B60T 13/588; F16D 2125/06

(57) ABSTRACT

A bake piston, which is arranged on a brake caliper of a disc brake of a vehicle, has a first and a second tubular piston body portion which are connected together at a first axial end of the brake piston via an annular end wall. The second piston body portion forms a receptacle in which a spindle nut of a spindle drive is accommodated so as to be axially displaceable and not rotatable relative to the brake piston, and receives a drive spindle. The first piston body portion has a radially inwardly directed floor region. The end wall is axially stepped towards the outside and has a radially outer portion and a radially inner portion which each have an end face pointing axially away from the brake piston, wherein the end face of the radially inner portion is axially offset relative to the end face of the radially outer portion in the direction towards the second axial end of the brake piston.

### CROSS-REFERENCE TO RELATED APPLICATION

This application claims priority to German Priority Application No. 102021128309.4, filed Oct. 29, 2021, the disclosure of which is incorporated herein by reference in its entirety.

### TECHNICAL FIELD

The disclosure concerns a brake piston, in particular for a disc brake of a vehicle.

### BACKGROUND

The brake piston is usually received displaceably in a cylindrical orifice which, for a fluidically actuatable brake, usually constitutes a fluid cylinder and a pressure chamber which can be loaded with pressurised fluid. Accordingly, by pressurisation of the pressure chamber, the brake piston can be moved in the direction of a brake pad which is thus pressed against an associated brake disc, and brakes this. The pressurised fluid here is usually a hydraulic fluid, so that in this case, the brake piston can be described as hydraulically actuated.

Alternatively or additionally, known brake pistons may also be coupled to an electrically actuatable spindle drive which moves the brake piston in the direction of the brake pad. The brake piston may also thus be electrically actuated. This is normally the case so that the brake caliper in which the brake piston is arranged, together with the associated brake disc, can be used as a parking brake.

### SUMMARY

What is needed is an improved brake piston.

Accordingly, a brake piston, for example for a disc brake of a vehicle, which has a first tubular piston body portion and a second tubular piston body portion arranged radially inside the first piston body portion, wherein both portions extend along a piston longitudinal axis. The first piston body portion and the second piston body portion are connected together at a first axial end of the brake piston via an annular end wall, so that an annular cavity is formed between the first piston body portion and the second piston body portion. At a second axial end of the brake piston, the second piston body portion is closed by a floor, so that the second piston body portion forms a receptacle. The first piston body portion has a radially inwardly directed floor region. The end wall is axially stepped towards the outside and has a radially outer portion and a radially inner portion, which each have an end face pointing axially away from the brake piston. In this exemplary arrangement, the end face of the radially inner portion is axially offset relative to the end face of the radially outer portion in the direction towards the second axial end of the brake piston.

The radially inner portion forms an axial depression in the end wall, so that a distance between the end wall of the brake piston and components of a brake piston drive is increased when the brake piston is in a position in which it is fully advanced towards the brake disc. This arrangement allows for a contact of a spindle flange of a spindle drive with the brake piston to be securely prevented in all positions of the brake piston. Thus installation of the brake and also a bleeding of the brake can always be guaranteed.

For example, the end face of the radially inner portion of the end wall is axially offset along an annular step, in the direction towards the second end of the brake piston. The dimensions of the axially inwardly offset region can easily be adapted during production to the dimensions of a spindle flange.

In one exemplary arrangement, the end wall delimits the annular cavity.

To improve the load transfer from the second piston body portion to the first piston body portion, and to improve the centring of the entire brake piston, a radially outer face of a region axially adjoining the floor of the second piston body portion may be formed conical and rest on a conical counter-face having a complementary cone angle, which is formed on the radially inwardly directed floor region of the first piston body portion. This gives a large superficial contact of the two piston body portions on the second axial end of the brake piston. With respect to the axial direction of the brake piston, the cone angle may e.g. be 45°.

In one exemplary arrangement, the floor region is designed to be annular all round, so that an axial force acting on the second piston body portion is conducted evenly into the first piston body portion.

In one exemplary arrangement, the conical counter-face is arranged on a radial end face of the floor region.

In one exemplary arrangement, an inside of the receptacle is conical at the region axially adjoining the floor of the second piston body portion and is configured to make contact with a counter-cone face of a spindle nut of a spindle drive in the receptacle of the second piston body portion. The axial force transmitted by the spindle nut may therefore be transmitted, by cone faces lying superficially against one another, initially to the second piston body portion and from there to the first piston body portion.

In order to optimise the force flow further, a radial end portion of the floor region of the first piston body portion runs axially obliquely inwardly, i.e. in the direction towards the first axial end of the brake piston, in the direction towards the conically formed outer face of the region axially adjoining the floor of the second piston body portion, (in one exemplary arrangement, at right angles), and rests outwardly on the second piston body portion. In one exemplary arrangement, the end portion meets the outer face at an angle of 90°.

In one exemplary arrangement, the floor region of the first piston body portion rests circumferentially all round on the outside of the second piston body portion. In one exemplary arrangement, the first piston body portion is not fixedly attached to the outside of the second piston body portion. However, a form-fit connection is advantageous in which the floor region of the first piston body portion rests with its cone surface on the cone surface of the second piston body portion over the entire circumference, in order to achieve an even force distribution.

A pressure face for loading a brake pad is positioned at an axially outwardly directed face of the floor region of the first piston body portion. This is the region via which the brake piston transmits an axial force to the brake pad, thereby actuating the disc brake.

The end portion of the floor region transforms radially outwardly into the portion of the floor region carrying the pressure face.

The first and second piston body portions may have a substantially constant wall thickness.

In one exemplary variant, the first and second piston body portions are two separately produced components which are connected together by form fit and/or material bonding in the region of the end face. This connection takes place in the region of the end face of the radially outer portion of the end wall of the brake piston. The material-bonded connection may be a weld connection. In addition, a form-fit connection may be provided by a corresponding design of the first piston body portion and the second piston body portion.

In one exemplary arrangement, one or both of the components may be deep-drawn parts, roll-formed parts or extrusions. Also for example, an extrusion may be further processed by roll-forming.

In one exemplary arrangement, no axial offset of the two components relative to one another is formed at the material-bonded connection. The annular end wall may be composed of surface portions of both piston body portions. The two piston body portions are connected for example at the end face of the radially outer portion of the end wall, so that the latter comprises portions of the first and second piston body portions.

In one exemplary arrangement, the only material-bonded connection between the first piston body portion and second piston body portion lies in this region. For example, only a form-fit contact between the two components is provided at the second axial end of the brake piston.

An outer circumferential face of the first piston body portion also comprises a running or slip face of the piston.

The brake piston according to the disclosure may be used in a brake which can be actuated both fluidically and via an electric brake piston drive, which e.g. comprises a spindle drive. It is also possible to use the brake piston in a brake which is actuated exclusively fluidically. The brake piston according to the disclosure may also be used in a brake which is actuated exclusively by an electric brake piston drive, i.e. used in a purely electromechanical brake.

For the case that the brake piston is displaceably received in the fluid cylinder and delimits the pressure chamber, the brake piston may be actuated fluidically, for example hydraulically.

If the brake piston is coupled exclusively to a brake piston drive comprising a spindle drive, this may be actuated purely electrically by the spindle drive. Such a brake caliper may be used for a parking brake. In this context, the brake is also described as an electric parking brake (EPB). Furthermore, such a brake caliper may be used for an electromechanical brake (EMB) which is also used during travel.

It is also possible that the brake piston is received in a fluid cylinder and delimits a pressure chamber, and is also coupled to a brake piston drive comprising a spindle drive. Then all above-mentioned functions may be implemented.

The disclosure also concerns a brake caliper for a disc brake of a vehicle, with an above-described brake piston which is displaceably received in a cylindrical orifice, and/or which is coupled to a brake piston drive comprising a spindle drive, wherein a spindle nut is accommodated in the receptacle of the second brake piston portion so as to be axially displaceable and not rotatable relative to the brake piston, and receives a drive spindle.

### BRIEF DESCRIPTION OF DRAWINGS

The disclosure is described in more detail below with reference to an exemplary arrangement shown on the appended figures. In the drawings:

FIG. 1 shows a schematic illustration of a brake caliper with a brake piston;

FIG. 2 shows a perspective illustration of a brake piston according to the disclosure; and

FIG. 3 shows a schematic sectional view of a brake piston drive with a brake piston according to the disclosure.

### DETAILED DESCRIPTION

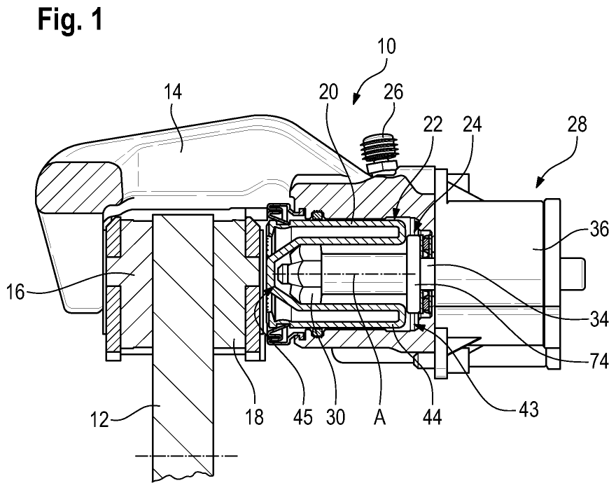

FIG. 1 shows a brake caliper 10 of a disc brake of a vehicle, which cooperates with a brake disc 12.

The brake caliper 10 comprises a brake caliper body 14 on which a first brake pad 16 is attached. The first brake pad 16 is thus held immovably on the brake caliper body 14.

In addition, a second brake pad 18 is provided which is displaceably mounted on the brake caliper body 14 so that it can be optionally pressed against the brake disc 12 by a brake piston 20, in order to achieve a braking effect.

To this end, the brake piston 20 is displaceably mounted in a cylindrical orifice, here e.g. a fluid cylinder 22, which is formed on the brake caliper body 14.

A pressure chamber 24, which can be loaded with pressurised fluid, is delimited by an end of the fluid cylinder 22 facing away from the brake disc 12, and the brake piston 20.

The pressure chamber 24 is fluidically connected to a pressurised fluid connection 26, via which a pressurised fluid can be optionally introduced into and discharged from the pressure chamber 24.

For example, the pressurised fluid may be a hydraulic fluid. Thus the fluid cylinder 22 is a hydraulic cylinder. The brake piston 20 can thus be moved hydraulically towards the brake pad 18 and brake disc 12, so that the brake pad 18 bears on the brake disc 12 and brakes this.

In addition, here the brake piston 20 is coupled to a brake piston drive which, in the exemplary arrangement illustrated, is a spindle drive 28.

A spindle nut 30 of the spindle drive 28 is mounted on the brake piston 20 so as to be rotationally fixed but axially displaceable along a piston longitudinal axis A.

The spindle nut 30 cooperates with a drive spindle 34 of the spindle drive 28, which is mounted on the brake caliper body 14 so as to be rotatable about the longitudinal axis A of the brake piston 20 but is otherwise stationary. The drive spindle 34 can optionally be set in rotation by an electric drive motor 36.

Thus the brake piston 20 can also be moved by the spindle drive 28 onto the brake pad 18 and brake disc 12, so that the brake pad 18 is pressed against the brake disc 12 and brakes this.

In one exemplary arrangement, the brake piston 20 may also be used in a purely electromechanical brake.

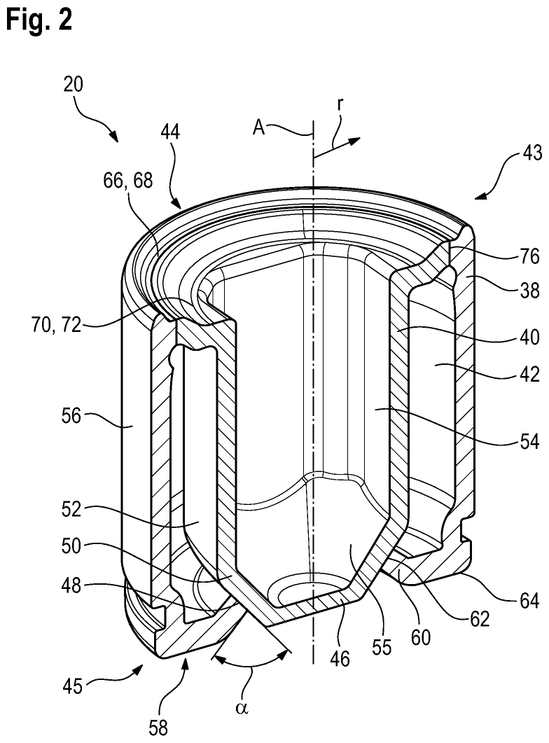

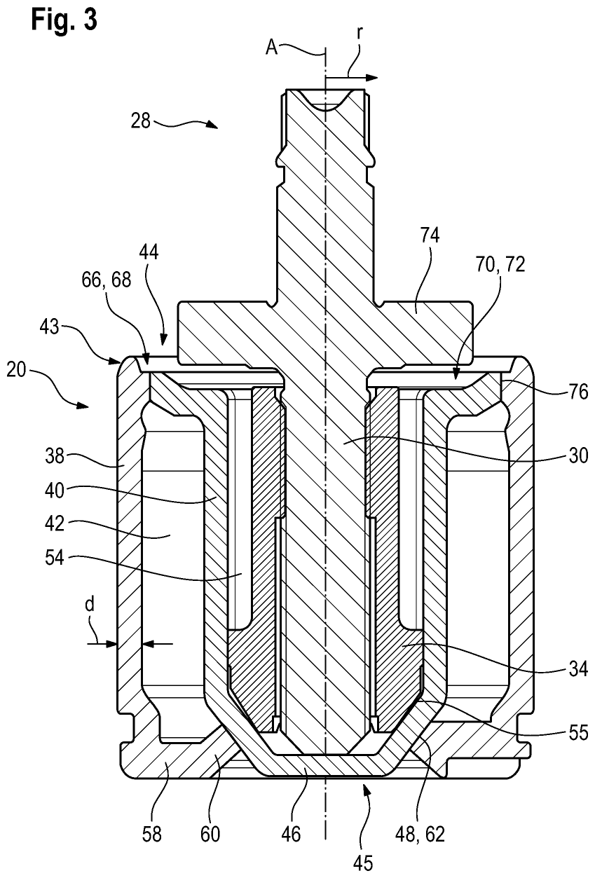

FIGS. 2 and 3 shows the brake piston 20 in detail.

The brake piston 20 includes a first tubular piston body portion 38 and a second tubular piston body portion 40. Both piston body portions 38, 40 extend along the piston longitudinal axis A.

The second piston body portion 40 is arranged radially inside the first piston body portion 38, forming an annular cavity 42 between itself and the piston body portion 38.

The first piston body portion 38 and the second piston body portion 40 are connected together at a first axial end 43 of the brake piston 20 via an annular end wall 44. The annular end wall 44 thus also delimits the cavity 42 in the axial direction.

In addition, at its end opposite the end wall 44 along the piston longitudinal axis A, the second piston body portion 40 is axially closed by a floor 46 at a second axial end 45 of the brake piston 20. The surface of the floor 46 is here flat and stands perpendicular to the piston longitudinal axis A.

An outer face 48 of a region 50 axially adjoining the floor 46 is formed conical and widens towards the first axial end 43 of the brake piston 20, until it transforms into an at least approximately cylindrical portion 52.

Radially in its inside, the second piston body portion 40 forms a receptacle 54 in which the spindle nut 30 is received.

The spindle nut 30 is received inside the receptacle 54 rotationally fixedly, i.e. because of the non-round cross-section of the receptacle 54, but is displaceable along the longitudinal axis A.

An end of the spindle nut 30 pointing towards the second axial end 45 of the brake piston 20 is here formed conical, and lies on a conical inside 55 of the receptacle 54 having a complementary angle.

The first piston body portion 38 here has a substantially cylindrical outer face 56 which extends from the first axial end 43 to the second axial end 45 of the brake piston 20. At the second axial end 45, the outer face 56 transforms integrally into a radially inwardly directed floor region 58. In its radially end portion 60, the floor region 58 is bent in the direction towards the first axial end 43 and terminates in a circumferential face which forms a conical counter-face 62 to the conical outer face 48 of the region 50 of the second piston body portion 40. The floor region 58 thus has a central orifice through which the floor 46 of the second piston body portion 40 protrudes. The inner diameter of the orifice is smaller than the outer diameter of the portion 52 of the second piston body portion 38.

The cone angles of the conical outer face 48 and conical counter-face 62 are complementary. The first piston body portion 38 and second piston body portion 40 in this region lie flat against one another by form fit over the entire periphery, without being fixed to one another.

The geometries of the radial end portion 60, the conical outer face 48 and conical counter-face 62 are here selected such that the end portion 60 meets the conical outer face 48 at an angle α of 90°.

At the axially outwardly pointing face of the floor region 58, a pressure face 64 is formed which serves to be placed against the brake pad 18, i.e. to load this with a force.

The pressure face 64 here extends in substantially annular fashion in the radially outer portion of the floor region 58.

The end wall 44 is axially stepped. A radially outer portion 66 forms a radially outer end face 68, while a radially inner portion 70 forms a radially inner end face 72, which is arranged further offset in the axial direction A towards the second axial end 45 than the radially outer end face 68. The axial step thus formed between the end face 68 and the end face 72 is here formed circumferentially evenly all round.

This results in a depression of the end wall 44 radially adjoining the receptacle 54 in the first piston body portion 38.

The region between the end faces 68 and 72 is conical.

In its shape and size, this depression is adapted to the shape and clearance of movement of a spindle flange 74 which is arranged outside the receptacle 54 on the drive spindle 34.

The spindle nut 30 always sits between the floor 46 of the receptacle 54 and the spindle flange 74 (see FIG. 3).

The brake piston 20 here includes two separately produced components which correspond to the first piston body portion 38 and the second piston body portion 40. At the end wall 44, the two components are joined together permanently and fixedly by form fit and material bonding, here by a weld connection sector 76. The weld connection 76 here lies in the region of the end face 68 of the radially outer portion 66 of the wall 44, so that this end face 68 is formed both by the first piston body portion 38 and also by the second piston body portion 40.

The radial edges of the two components here run in the longitudinal direction A so that they are connected together in the radial direction r.

The two components rest against one another purely by form fit at the second axial end 45 and, in this example, there is no material-bonded connection at this point.

The wall thicknesses d of the first and second piston body portions 38, 40 are here substantially constant and may be approximately the same. The two components may for example be produced by deep-drawing or in a process which comprises one or more deep-drawing steps.

Starting from the position of the brake piston 20 shown in FIG. 1, this can be moved to the left by pressurisation of the pressure chamber 24 or by actuation of the spindle drive 28, so that it bears on the brake pad 18 and presses the latter onto the brake disc 12. This provokes a braking effect.

On use of the spindle drive 28, the electric drive motor 36 is activated and sets the drive spindle 38 in rotation. This moves the spindle nut 30 to the left. As soon as the spindle nut 30 meets the floor 46 of the brake piston 20, it carries the brake piston 20 with it in its movement to the left.

In this state, the spindle flange 74 does not touch the end wall 44, since the radially inner end face 72 is offset far enough in the direction towards the second axial end 45 to maintain a sufficient distance from the underside of the spindle flange 74. This is shown in FIG. 3.

1. A brake piston for a disc brake of a vehicle, with a first tubular piston body portion and a second tubular piston body portion arranged radially inside the first piston body portion, wherein both portions extend along a piston longitudinal axis, wherein the first piston body portion and the second piston body portion are connected together at a first axial end of the brake piston via an annular end wall, so that an annular cavity is formed between the first piston body portion and the second piston body portion,
wherein at a second axial end of the brake piston, the second piston body portion is closed by a floor so that the second piston body portion forms a receptacle, and the first piston body portion has a radially inwardly directed floor region, and
wherein the end wall is axially stepped towards an outside and has a radial outer portion and a radial inner portion which each have an end face pointing axially away from the brake piston, wherein the end face of the radial inner portion is axially offset relative to the end face of the radial outer portion in the direction towards the second axial end of the brake piston.

2. The brake piston according to claim 1, wherein the end face of the radial inner portion of the end wall is axially offset along an annular step, in a direction towards the second end of the brake piston.

3. The brake piston according to claim 1, wherein a radially outer face of a region axially adjoining the floor of the second piston body portion is formed conical and lies on a conical counter-face having a complementary cone angle, which is formed on the radial inwardly directed floor region of the first piston body portion.

4. The brake piston according to claim 3, wherein an inside of the receptacle is conical at the region axially adjoining the floor of the second piston body portion and is configured to make contact with a counter-cone face of a spindle nut of a spindle drive in the receptacle of the second piston body portion.

5. The brake piston according to claim 3, wherein a radial end portion of the floor region of the first piston body portion runs axially obliquely inwardly in a direction towards the conically formed outer face of the region axially adjoining the floor of the second piston body portion, and rests outwardly on the second piston body portion.

6. The brake piston according to claim 3, wherein the floor region of the first piston body portion rests circumferentially all round on the outer face of the second piston body portion, without being attached to the outer face.

7. The brake piston according to claim 1, wherein a pressure face for loading a brake pad is positioned at an axially outwardly directed face of the floor region of the first piston body portion.

8. The brake piston according to claim 1, wherein the first and second piston body portions have a substantially constant wall thickness.

9. The brake piston according to claim 1, wherein the first and second piston body portions are two separately produced components which are connected together by form fit and/or material bonding in a region of the end wall.

10. The brake caliper for a disc brake of a vehicle, with a brake piston according to claim 1, wherein the brake piston is displaceably received in a cylindrical orifice and/or wherein the brake piston is coupled to a brake piston drive comprising a spindle drive, wherein a spindle nut is accommodated in the receptacle of the second brake piston portion so as to be axially displaceable and not rotatable relative to the brake piston, and receives a drive spindle.

11. The brake piston according to claim 2, wherein a radially outer face of a region axially adjoining the floor of the second piston body portion is formed conical and lies on a conical counter-face having a complementary cone angle, which is formed on the radial inwardly directed floor region of the first piston body portion.

12. The brake piston according to claim 11, wherein an inside of the receptacle is conical at the region axially adjoining the floor of the second piston body portion and is configured to make contact with a counter-cone face of a spindle nut of a spindle drive in the receptacle of the second piston body portion.

13. The brake piston according to claim 12, wherein a radial end portion of the floor region of the first piston body portion runs axially obliquely inwardly in a direction towards the conically formed outer face of the region axially adjoining the floor of the second piston body portion and rests outwardly on the second piston body portion.

14. The brake piston according to claim 5, wherein the radial end portion of the floor region runs axially obliquely inwardly at right angles toward the conically formed outer face of the region axially adjoining the floor.

15. The brake piston according to claim 13, wherein the floor region of the first piston body portion rests circumferentially all round on the outer face of the second piston body portion, without being attached to the outer face.

16. The brake piston according to claim 3, wherein a pressure face for loading a brake pad is positioned at an axially outwardly directed face of the floor region of the first piston body portion.

17. The brake piston according to claim 16, wherein the first and second piston body portions have a substantially constant wall thickness.

18. The brake piston according to claim 3, wherein the first and second piston body portions are two separately produced components which are connected together by form fit and/or material bonding in a region of the radially outer portion (68) of the end wall (44).
